(19) United States
(12) Patent Application Publication
(10) Pub. No.: US 2011/0204171 A1
(43) Pub. Date: Aug. 25, 2011

(54) Replaceable insert for a hammermill hammer

(76) Inventor: Matt H. Craven, Modesto, CA (US)

(21) Appl. No.: 12/659,064

(22) Filed: Feb. 24, 2010

(51) Int. Cl. B02C 13/28

(52) U.S. Cl. 241/197; 241/300

(57) ABSTRACT

The replaceable insert for a hammermill hammer enables the insert to be removed and replaced by the removal and installation of a single bolt in the leading face or edge of the hammer, rather than requiring partial disassembly of the hammermill for the removal of a damaged hammer and hammer shank from its retaining rod. The insert is formed of hard and tough metal, e.g., tool steel, carbide alloy, etc., as a longitudinally and laterally symmetrical rectangular parallelepiped, the hammer shank having a cooperating relief formed therein. The symmetrical configuration allows the insert to be reversed through 180° in its installation, thereby exposing a fresh insert face after the first face has been worn or damaged. A pair of indexing pins extends from the insert, the pins fitting closely within cooperating receptacles in the hammer shank relief to secure the insert precisely within the relief.

### BACKGROUND OF THE INVENTION

1. Field of the Invention

The present invention relates generally to power equipment used for the shredding, pulverizing, and comminuting of material, and particularly to a replaceable insert for a hammer as used in powered hammermills and the like.

2. Description of the Related Art

Hammermills have been used for a considerable time for shredding, pulverizing, and comminuting a wide range of different types of materials. Such machines are used for shredding metal for recycling, pulverizing nuts, grains, and other food products in food processing, shredding and breaking up woody materials for use as mulch, and innumerable other purposes and operations.

Hammermills are generally constructed with a plurality of axially parallel shafts that rotate around a central axis, with each shaft having a plurality of hammers or hammer shanks pivotally installed thereon. The hammers are thrown outwardly during high speed rotation of the machine due to centrifugal effect, with their masses resulting in the shredding and pulverizing of the material being processed.

Accordingly, the hammers or hammer shanks are generally manufactured of hard and durable materials, e.g., steel, etc. Even harder materials are commonly used on the forward faces of the hammers, with a layer of carbide often being welded to the leading or cutting edges or faces of such hammers. While carbide is extremely hard and resistant to wear, it is relatively brittle and often cracks or breaks away from the base metal to which it has been welded. This necessitates replacement of the entire hammer shank, which requires at least partial disassembly of the hammermill to remove the shank from its retaining rod and to replace the hammer shank with a new one.

Moreover, such conventional hammer shanks are generally not symmetrical, i.e., they cannot be removed from their rods and turned around 180° to exchange the leading and trailing edges to provide a fresh leading or cutting edge. When such conventional hammer shanks are worn or damaged, they must be discarded after removal and replaced with a new hammer shank.

The present inventor is aware of various hammermill hammers and attachments that have been developed in the past. An example of such is found in European Patent No. 388,825 published on Sep. 26, 1990. This publication describes (according to the drawings and English abstract) a hammer shank with a replaceable asymmetric extension having a generally L-shaped cross section. The shorter tip of the extension has a carbide cutting edge attached thereto, with the edge having a specifically formed angle.

None of the above inventions and patents, taken either singly or in combination, is seen to describe the instant invention as claimed. Thus, a replaceable insert for a hammermill hammer solving the aforementioned problems is desired.

### SUMMARY OF THE INVENTION

The replaceable insert for a hammermill hammer is formed as a longitudinally and laterally symmetrical rectangular parallelepiped, enabling the insert to be reversed through 180° to expose a fresh leading or cutting edge or face when the first edge or face is worn or damaged. The hammer shank is adapted to accept the insert, by machining an insert relief in the leading edge of the shank. The insert is formed of a suitably hard and/or tough metal, e.g., tool steel, various carbide alloys, etc., and includes a pair of indexing pins that fit closely within cooperating receptacles within the relief of the hammer shank. The hammer shank relief also includes a threaded passage, the insert having an unthreaded passage therethrough for an attachment bolt.

The replaceable insert enables the hammermill operator to reverse or replace the insert in the hammer shank without disassembling the hammermill to remove the hammer shank from its retaining rod. The operator need only position the hammer shank having the worn or damaged insert so that it is accessible, unbolt the worn or damaged insert from its hammer shank, and either reverse the insert to expose a fresh leading or cutting surface or install a new insert. Thus, a hammer shank can be repaired very simply and quickly with the removal and installation of a single bolt, rather than having to at least partially disassemble the hammermill to replace the entire hammer shank.

These and other features of the present invention will become readily apparent upon further review of the following specification and drawings.

### BRIEF DESCRIPTION OF THE DRAWINGS

FIG. 1 is an environmental perspective view of a hammermill hammer and a replaceable insert for a hammermill hammer according to the present invention shown exploded from the hammer.

FIG. 2 is an environmental side elevation view in section of the hammermill hammer and the replaceable insert of FIG. 1, shown with the insert assembled to the hammer.

FIG. 3 is a front elevation view of the replaceable insert for a hammermill hammer according to the present invention, showing further details thereof:

Similar reference characters denote corresponding features consistently throughout the attached drawings.

### DETAILED DESCRIPTION OF THE PREFERRED EMBODIMENTS

The replaceable insert for a hammermill hammer is attachable to the hammer or hammer shank of a powered hammermill, as used in the shredding, pulverizing, and/or comminuting of various materials. The replaceable insert and its specially configured hammer or hammer shank allow the insert to be replaced when worn or damaged without requiring partial disassembly of the hammermill to remove the entire hammer or shank.

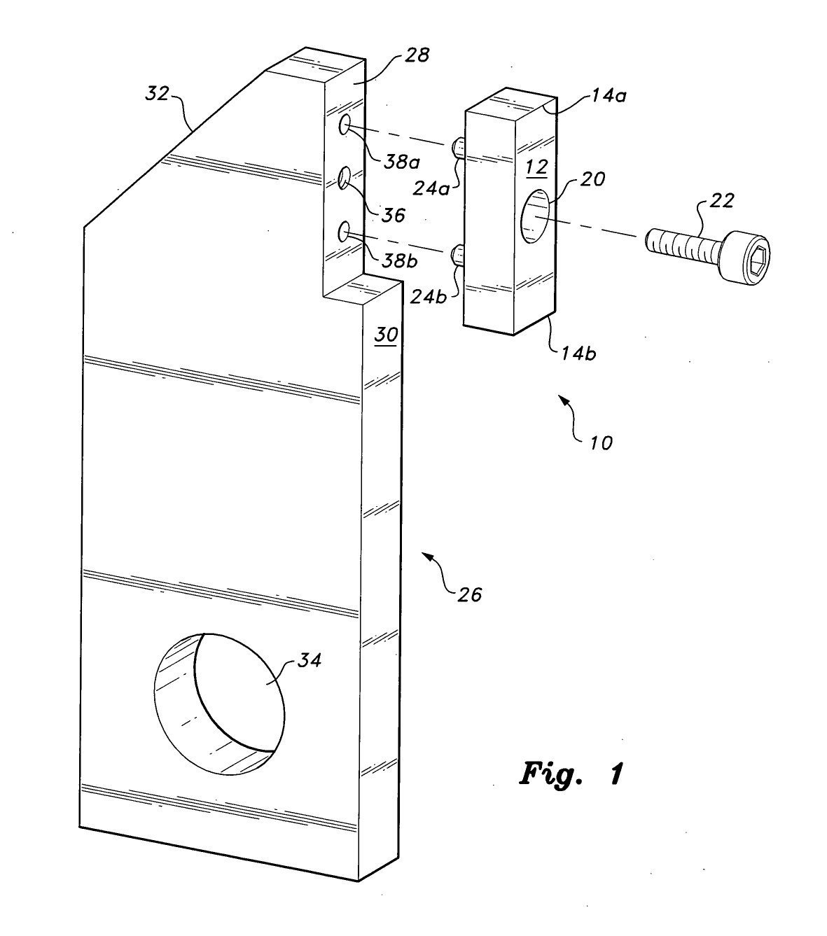

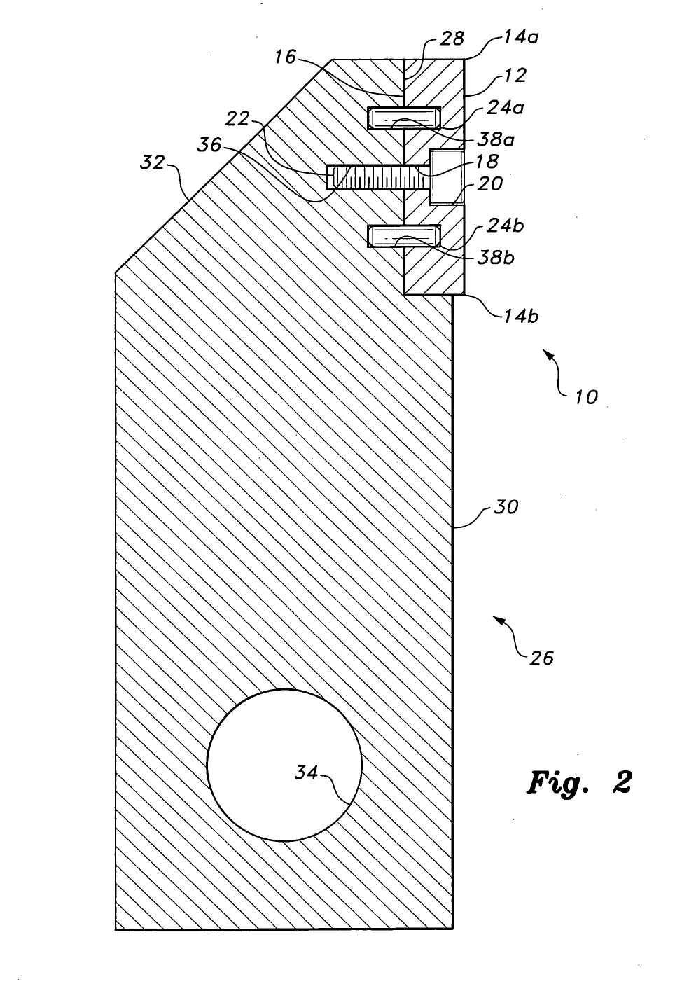

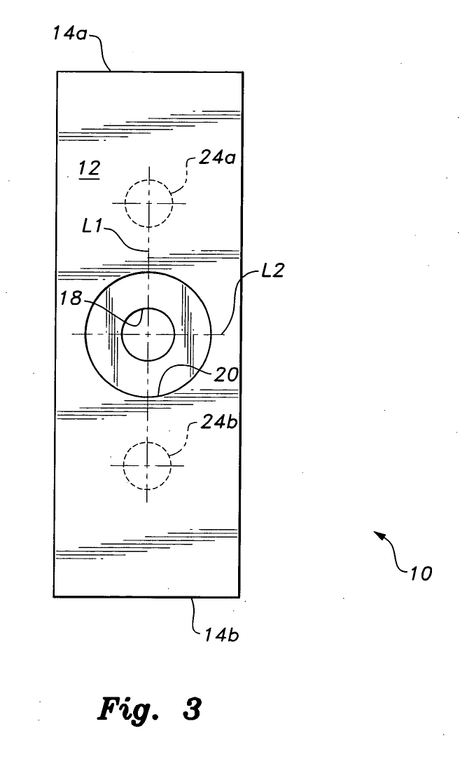

FIGS. 1 and 2 respectively provide an exploded perspective view and a side elevation view in section of the hammer and insert or block, with FIG. 3 being a front elevation view of the insert. The insert block 10 is formed of a hard metal or metal alloy, e.g., tool steel, high carbon steel, carbide or carbide alloys, tungsten, or tungsten alloys, or other hard metals or alloys as desired. More ductile metals are preferably used, in order to reduce or preclude cracking, chipping, and fracturing that often occur with more brittle materials.

The insert block 10 is formed (e.g., machined, etc.) to have a substantially solid rectangular parallelepiped shape or configuration with symmetry about its longitudinal axis L1 and lateral axis L2, as shown in FIG. 3 of the drawings. The insert block 10 includes a working face 12 having mutually opposed first and second edges, respectively 14a and 14b, and an attachment face 16, shown in FIG. 2, opposite and parallel to the working face 12. An unthreaded fastener passage 18, shown in FIGS. 2 and 3, is formed essentially centrally through the insert block 10 from the working face 12 through to the attachment face 16. The working face 12 has a countersink 20 therein for accepting an appropriately configured fastener 22, e.g., an Allen head bolt, as shown in FIGS. 1 and 2.

The insert block 10 further includes permanently installed (e.g., press fit, etc.) first and second indexing pins, respectively 24a and 24b, that extend from the attachment face 16. The two pins 24a, 24b are parallel to one another and to the axis of the fastener passage 18, and are symmetrically disposed about the central fastener passage 18. The two pins 24a, 24b and the fastener passage 18 are mutually coplanar along the longitudinal centerline L1 of the insert block 10, as well.

The hammer or hammer shank 26 is specially configured to accept the insert block 10 thereon. The hammer 26 includes an insert relief 28 formed in its leading edge or face 30 along the outboard portion 32 thereof, i.e., the portion of the hammer 26 opposite its attachment end and retaining rod passage 34. The insert relief 28 of the hammer 26 is formed (machined, etc.) to fit the square corner of either end and attachment face 16 of the insert block 10, and includes a threaded fastener passage 36 and first and second index pin passages, respectively 38a and 38b, therein. The two pin passages 38a, 38b are symmetrically disposed to each side of the centrally positioned threaded fastener passage 36 and coplanar therewith as shown in the section view of FIG. 2, with the two pin passages 38a, 38b and the threaded fastener passage 36 of the hammer or hammer shank 26 aligning with the respective indexing pins 24a, 24b and fastener passage 18 of the insert block 10 when it is installed in the relief 28 of the hammer 26.

The insert block 10 installs in the relief 28 of the hammer 26 essentially as shown in FIGS. 1 and 2, with the attachment face 16 of the insert 10 abutting the face of the insert relief 28 of the hammer 26. It will be seen that the longitudinally symmetrical nature of the insert block 10 allows it to be installed in the relief 28 of the hammer 26 in either of two positions. A first position is as shown in FIGS. 1 and 2, i.e., with the pin 24a inserting into the corresponding passage 38a and the pin 24b inserting into the corresponding pin passage 38b of the hammer 26, with the first edge 14a oriented most distally from the attachment end and retaining rod passage 34 of the hammer 26. When turned 180 degrees, the second pin 24b of the insert block 10 installs in the first passage 38a of the hammer 26 and the first pin 24a installs in the second passage 38b, with the second edge 14b of the insert 10 oriented away from the rod passage 34 of the hammer 26.

Accordingly, the removable and replaceable nature of the insert block 10 greatly simplifies the maintenance and repair of worn and/or damaged hammers or hammer shanks in a hammermill. Rather than requiring the hammermill to be at least partially dismantled in order to remove a worn or damaged hammer in its entirety, the hammermill need only be shut down and the subject hammer or hammer shank positioned for access by maintenance personnel. The mechanic need only remove the single bolt or fastener 22 from the worn or damaged insert 10 and remove the insert from the hammer 26, with the hammer remaining in its installed state on the retaining rod of the hammermill. If only one edge or end of the insert 10 has been damaged or worn, the insert 10 may be turned through 180 degrees about the axis defined by the central fastener passage 18 and reinstalled with the fresh cutting edge or end positioned distally from the retaining rod end and passage 34 of the hammer 26, essentially doubling the life of the insert 10. Once both edges or ends 14a and 14b have been worn or damaged, the insert 10 may be removed as described above and a new insert 10 installed in its place to continue hammermill operation.

It is to be understood that the present invention is not limited to the embodiment described above, but encompasses any and all embodiments within the scope of the following claims.

I claim:

1. A replaceable insert for a hammermill hammer, comprising a block having a substantially solid rectangular parallelepiped configuration, the block being longitudinally and laterally symmetrical, the block having a working face defining longitudinally opposed first and second working edges, the block being adapted for removable and longitudinally reversible installation upon the hammermill hammer's leading edge.

2. The replaceable insert according to claim 1, wherein the block has an attachment face opposite the working face and a fastener passage formed through the block from the working face to the attachment face, the replaceable insert further comprising first and second hammer indexing pins extending from the attachment face of the block, the pins being symmetrically disposed, the fastener passage being centered between the pins.

3. The replaceable insert according to claim 2, wherein the fastener passage is coplanar with the pins.

4. The replaceable insert for a hammermill hammer according to claim 1, further including a hammermill hammer having a leading edge and an insert relief formed in the leading edge, the relief having first and second indexing pin passages defined therein and a threaded fastener passage centrally disposed between the indexing pin passages, the insert block having an attachment face opposite the working face and a fastener passage formed through the block from the working face to the attachment face, the insert further comprising first and second hammer indexing pins extending from the attachment face of the block, the pins being symmetrically disposed, the fastener passage being centered between the pins, the pins removably installing within the indexing pin passages of the hammer, the fastener passage of the block aligning with the threaded fastener passage of the hammer so that a single threaded fastener may removably secure the block within the insert relief of the hammer.

5. The replaceable insert according to claim 1, wherein the block has an attachment face opposite the working face and a fastener passage formed through the block from the working face to the attachment face, the fastener passage having a countersink defined in the working face of the block.

6. The replaceable insert according to claim 1, wherein the block is formed of at least one material selected from the group consisting of tool steel, high carbon steel, carbide, carbide alloys, tungsten, and tungsten alloys.

7. A replaceable insert for a hammermill hammer, comprising:
a block having a working face defining longitudinally opposed first and second working edges, an attachment face opposite the working face, and a fastener passage formed through the block from the working face to the attachment face; and
first and second hammer indexing pins extending from the attachment face of the block, the pins being symmetrically disposed, the fastener passage being centered between the pins.

8. The replaceable insert according to claim 7, wherein the fastener passage is coplanar with the pins.

9. The replaceable insert according to claim 7, wherein the block has a substantially solid rectangular parallelepiped configuration, the block being longitudinally and laterally symmetrical, the block being adapted for removable and longitudinally reversible installation upon the hammermill hammer's leading edge.

10. The replaceable insert according to claim 7, further including:
a hammermill hammer having a leading edge and an insert relief formed in the leading edge of the hammer, the relief having first and second indexing pin passages disposed therein and a threaded fastener passage centrally disposed between the indexing pin passages, the pins of the insert block being removably installable within the indexing pin passages of the hammer, the fastener passage of the block aligning with the threaded fastener passage of the hammer; and
a single threaded fastener removably disposed through the fastener passage of the block and into the threaded fastener passage of the hammer to removably secure the block within the insert relief of the hammer.

11. The replaceable insert according to claim 7, wherein the fastener passage has a countersink defined in the working face of the block.

12. The replaceable insert according to claim 7, wherein the block is formed of at least one material selected from the group consisting of tool steel, high carbon steel, carbide, carbide alloys, tungsten, and tungsten alloys.

13. A hammermill hammer and replaceable insert therefor, comprising in combination:
a hammermill hammer having a leading edge, an insert relief being formed in the leading edge, the relief having first and second indexing pin passages defined therein and a threaded fastener passage centrally disposed between the indexing pin passages;
an insert block having a working defining longitudinally opposed first and second working edges, an attachment face opposite the working face, and a fastener passage formed through the block from the working face to the attachment face;
first and second hammer indexing pins extending from the attachment face of the block, the pins being symmetrically disposed, the fastener passage being centered between the pins, the pins being removably installable within the indexing pin passages of the hammer, the fastener passage of the block aligning with the threaded fastener passage of the hammer; and
a single threaded fastener removably disposed through the fastener passage of the block and into the threaded fastener passage of the hammer to removably secure the block within the insert relief of the hammer.

14. The hammermill hammer and replaceable insert combination according to claim 13, wherein the insert block has a substantially solid rectangular parallelepiped configuration, the block being longitudinally and laterally symmetrical, the block being adapted for longitudinally reversible installation within the insert relief of the hammermill hammer.

15. The replaceable insert for a hammermill hammer according to claim 13, wherein the fastener passage of the block is coplanar with the pins.

16. The replaceable insert for a hammermill hammer according to claim 13, wherein the fastener passage has a countersink defined in the working face of the block.

17. The replaceable insert for a hammermill hammer according to claim 13, wherein the block is formed of at least one material selected from the group consisting of tool steel, high carbon steel, carbide, carbide alloys, tungsten, and tungsten alloys.
